(19) United States
(12) Patent Application Publication
(10) Pub. No.: US 2009/0234573 A1
(43) Pub. Date: Sep. 17, 2009

(54) Travel Partner Matching Using Selectable Map Interface

(75) Inventor: John Notarantonio, Marietta, GA (US)

Correspondence Address: FISH & RICHARDSON P.C., P.O BOX 1022, Minneapolis, MN, 55440-1022, US

(73) Assignee: EMORY UNIVERSITY OFFICE OF TECHNOLOGY TRANSFER, Atlanta, GA (US)

(21) Appl. No.: 12/049,786

(22) Filed: Mar. 17, 2008

(51) Int. Cl. G01C 21/00

(52) U.S. Cl. 701/201; 701/209; 701/212; 701/200; 705/14; 705/400

(57) ABSTRACT

Systems and methods for travel partner matching using a map-based user selectable interface. A user can search for potential travel partner matches using a map-based user selectable interface. In various implementations, the map-based user selectable interface can provide cost savings estimations based upon a potential travel partner selected and/or a communications interface to communicate with potential travel partners, among many others.

### BACKGROUND AND FIELD

This disclosure relates to finding a travel partner match.

Public transportation systems have been in use for years. Some options of public transportation include subways, trains, buses, taxis, and trolley cars. Certain forms of public transportation have routes with specific schedules. These routes can sometimes create a need to transfer between modes of transportation or transportation vehicles in order for a commuter to get to their destination.

Commuters in highly populated metro areas often use public transportation to get to work, concerts, or other special events. Public transportation can reduce the stress of having to worry about traffic, where to park and navigating through one way streets. Commutes can often be more productive when public transportation is used, allowing commuters to work or read during the commute.

Another option for commuting is driving a single occupancy vehicle (SOV) to work. This can cause delays due to traffic and weather, and stress because of the commute. Driving a SOV may also reduce productivity if the commuter has the ability to work while in transit to the work place because more of the commuter's day is spent working and getting to and from work.

Carpooling and vanpooling are modes of transport that allow commuters to use high occupancy vehicle (HOV) lanes where available. HOVs often reduce commute times and stress, and allow passengers the ability to work or read on their way to work. Commuters can often find people to share a carpool with from their own neighborhood, which can build upon the sense of community in the area.

### SUMMARY

Systems, methods, apparatuses and computer readable media are provided for locating potential travel partners. In some implementations, methods for travel partner searching can include: storing geocoded locations associated with a plurality of users, including a searcher, the geocoded locations comprising geocoded origin information and geocoded destination information; providing a primary interface comprising a map-based user selectable interface for presentation to the searcher, retrieving the geocoded locations associated with the plurality of users; identifying the plurality of users on the map-based user selectable interface based upon the retrieved geocoded origin information; receiving a hover indication from the user through the map-based user selectable interface, the hover indication being associated with a current location within the map-based user interface; presenting a cost-savings estimation to the searcher within the map-based user selectable interface based upon the hover indication; receiving input from the searcher identifying a selected user; and providing a communications interface to the searcher based upon receiving input from the searcher identifying the selected user, the communications interface being operable to facilitate communications between the searcher and the selected user.

In some examples, systems for travel partner searching can include a user location data store, an interface module and a communications module. The user location data store can store geocoded locations associated with users (e.g., including a searcher). The geocoded locations can include geocoded origin information and geocoded destination information associated with the users. The interface module can generate a primary interface including a map-based user selectable interface for presentation to the searcher. The interface module can provide a map-based user selectable interface operable to provide location markers associated with the users within the map-based user selectable interface, whereby selecting a location marker is operable to produce a cost savings estimation as well as a communications link to a user associated with the selected location marker. Selection of the communications link can cause the communications module to provide a communications interface to the searcher through the interface module, the communications module and communications interface being further able to facilitate communications between the searcher and the selected user. The map-based user selectable interface can further update an associated map based upon input received from the searcher.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustrating an example travel partner location system.

FIG. 2 is a flowchart illustrating an example method for travel partner matching.

FIG. 3 is a flowchart illustrating an example method for estimating cost savings.

FIG. 4 is a flowchart illustrating an example method for contacting a potential travel partnership participant.

FIG. 5 is a flowchart illustrating an example method for adjusting a cost savings estimate.

FIG. 6 is a flowchart illustrating an example method for managing travel partnership incentives.

FIG. 7 is screen shot representation illustrating an example map-based user selectable map interface showing potential travel partner matches.

FIG. 8 is a screen shot representation illustrating another example map-based user selectable interface having a current location indication and a selectable communications link.

FIG. 9 is a screen shot representation illustrating another example map-based user selectable interface including a current location indication, a selectable communications link and a cost savings adjustment link.

FIG. 10 is a screen shot representation illustrating another example user-selectable map interface showing potential travel partners users using truncated geocode information.

FIG. 11 is a screen shot representation illustrating an example communications interface used to contact potential travel partner matches.

### DETAILED DESCRIPTION

Travel partner search systems and methods can provide a primary interface including a user-selectable map interface to the user, allowing the user to visually locate potential travel partners. Travel partners, in various examples, can include travel partners, carpools, road trips, walking or bicycling partners. In some implementations, systems and methods can provide a secondary interface including a communications interface whereby a user can communicate with potential travel partners. Systems and methods for travel partner finding can also obfuscate personal information, including, for example, contact information, address information, and name until a user has chosen to make that information available to another user. In some implementations, a cost savings estimate can be provided to the user based upon a currently selected location. In further implementations, the user can adjust cost savings factors to provide a better cost savings estimate.

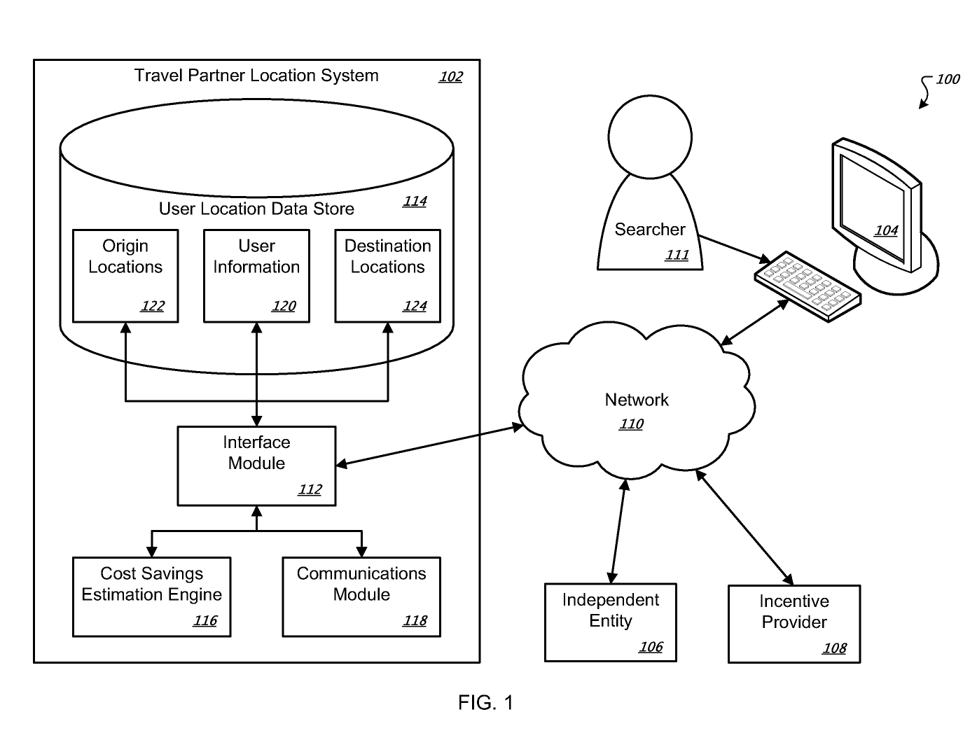

FIG. 1 is a block diagram illustrating an example travel partner location system 102. In some implementations, the travel partner location system 100 can communicate with a user device 104, an independent entity 106, and an incentive provider 108 through a network 110. The travel partner location system 102 can, for example, be accessed by a searcher 111 using the user device 104. The searcher 111 can use the travel partner location system 102 to locate potential travel partner matches. In various examples, the destination of the traveling can be for work, home, a sporting event, or school, among others. Moreover, the traveling can be by automobile, bus, rail, walking, bicycling, and tours, among others. In various implementations, the user device 104 can be a laptop computer or a mobile device, such as a cell phone or a Global Positioning System (GPS) system. The user device 104 can connect to the travel partner location system 102 through the network 110. In some implementations, the network 110 can be a wide area network (WAN), a local area network (LAN), a wireless network, the internet, a satellite, or some combination of networks, among others.

The travel partner location system 102 can send a map-based user selectable interface to the user device 104 displaying potential travel partner matches to the searcher 111. The searcher 111 can, for example, select a communications link to facilitate communications between the searcher 111 and the desired travel partner match. In some implementations, communications between the searcher 111 and the potential travel partner match can remain anonymous until both parties agree to a travel partnership trip, such as commuting to work, or agree to otherwise reveal their identities. In some implementations, the travel partner location system 102 can verify the travel partnership trip and certify that the travel partnership trip occurred. In further implementations, the incentive provider 108 can use the certification to retrieve an incentive for the searcher 111, the travel partner match, the travel partner location system 102, or combinations thereof.

In some implementations, users of the travel partner location system 102 are associated with the independent entity 106. The independent entity 106 can, for example, be a place of work, a school, or some other organization. The independent entity 106 can participate in the travel partner location system 102 to promote conservation of the environment by reducing traffic congestion issues and reducing carbon emissions. The travel partner location system 102 can, for example, display to a searcher associated with the independent entity 106 only travel partner matches that are associated with the same independent entity 106 and/or information on how much money and emissions the independent entity 106 has helped save. For example, the amount of money saved can factor in cost savings to commuters, to local governments due to less road repair, to reduction in carbon emissions, or cost savings to the independent entity 106, among others. Such collected statistics can be publicized by the travel partner location system 102 to provide advertising benefit to the independent entity 106.

In some implementations, the travel partner location system 102 can use the association with the independent entity 106, in addition to other associations and preferences/factors, to create social networking profiles and enhance the travel partner matching process. The associations and preferences/factors can, for example, include non-profit organizations, volunteer work, colleges and universities attended, social interests, speed preferences, route preferences or hobbies. In some implementations, the preferences/factors can include strength indicators indicating a strength associated with a preference/factor. For example, a user might indicate a strong preference against smoking. Such a user is unlikely to accept a travel partner with a user that smokes.

In some implementations, the travel partner location system 102 can include an interface module 112, a user location data store 114, a cost savings estimation engine 116, and a communications module 118. In some implementations, the travel partner location system 102 can be a network server, multiple servers, or a desktop computer. The travel partner location system 102, for example, can locate the interface module 112, the cost savings estimation engine 116, and the communications module 118 on one server, while the user location data store 114 is located on another server.

In some implementations, the interface module 112 can be used to generate a user selectable map interface to display travel partner information for communication to the user device 104 through the network 110. A searcher 111 can, for example, use a web interface, a widget, or other application residing on the user device 104 to view information provided by the interface module 112. The interface module 112 can request data or other information from the user location data store 114, the cost savings estimation engine 116, the communications module 118, or combinations thereof, to be included in the interface provided for display on the user device 104.

The user location data store 114 can include user information 120, origin information 122, and destination information 124. In some implementations, the origin and destination information 122, 124 can be coded using geocoding information. In further implementations the geocoding information can be truncated to hide the exact location of the user. The user location data store 114, in some implementations, can be provided by a database on the travel partner location system 102. The user information 120 can include information about each of the users registered with the travel partner location system 102 (e.g., through employment with the independent entity 106). For example, the user information 120 can include information on the searcher 111. The user information 120 can be associated with origin information 122 and destination information 124. The association between the user information 120 and location information 122, 124, for example, can be provided by metadata stored on the user location data store 114. In various examples, the user information 120 can be associated with multiple geocoded origin locations and geocoded destination locations, a single origin location and multiple destination locations, no destination location, or any other combination of origin locations and destination locations as provided by the origin and destination information 122, 124.

In some implementations, the user information 120 can include information about the users of the travel partner location system 102 such as, for example, full name, home address, and work address. Travel partner preferences can be included in the user information 120, such as smoking preference, or vehicle condition, to name a few examples. Other information can include a social networking profile, contact information such as home or work telephone number, home or work email address, or instant messaging contact information. In some implementations, the user information 120 can include a user name and password for logging into the travel partner location system 102 and an alias for anonymous communications with other travel partner users.

The origin and destination information 122, 124 can be stored on the user location data store 114 as latitude/longitude coordinates, street address, or IP address, to name a few examples. The origin and destination information 122 and 124 can be a user's home and work address, respectively. In some implementations, the origin information 122 and/or the destination information 124 can be geocoded, and can contain truncated geocode data. For example, the geocoded information can be a major intersection located near to a user's home address, truncated latitude/longitude coordinates, or some other form of truncated location data. The origin information 122 can include truncated geocode information in order to keep the identity of the users of the travel partner location system 102 anonymous to protect the privacy of those users. In some implementations, the system can group users together based upon similarity in the truncated geocode origin information associated with those users.

The destination information 124 can be similarly encoded using geocoding and can be truncated to a major intersection close to work, to truncated latitude/longitude coordinates, to a nearby point of interest, or some other truncated location data. In other implementations, the location information 122 and 124 can, for example, contain a combination of truncated and non-truncated data. For example, locations information 122 and 124 representing home and work geocoded locations can be truncated, while destination information 124 representing a geocoded address of a sporting event or a concert could be non-truncated data.

In some implementations, the cost savings estimation engine 116, for example, can provide a cost savings estimate to a user searching for a travel partner match (e.g., searcher 111). In various implementations, the cost savings estimate can be based on traffic congestion, availability of HOV lanes, parking availability, energy prices, insurance prices, carbon emissions, government or private incentives for carpooling, commute time, and/or potential commute tax deductions. In additional implementations, the cost savings estimate can be updated by the searcher 111 to reflect user specific information such as, for example, vehicle information (e.g., efficiency), current gas prices, insurance, or parking costs, among others.

In some implementations, the communications module 118 can facilitate communications between users of the travel partner location system 102. The communications module 118 can generate a communications interface for communication to the searcher 111.

In some implementations, the communications module 118 can provide anonymous communication between users. For example, the users can receive messages which direct them to retrieve messages from the travel partner location system, and the identity of the other participant(s) can remain unknown to the other until he/she reveals his/her identity. In still further examples, the user initiating a travel partner inquiry can have his/her identify revealed, while the receiving user only reveals his/her identity upon responding to the travel partner inquiry.

In other implementations, the communications module 118 can share contact information that users have selected as public information within the travel partner location system 102. The communications module 118 can provide a combination of undisclosed identity and disclosed identity communications. For example, communications can contain undisclosed identity information until both the searcher 111 and the potential travel partnership participant agree to exchange/share some or all identity information. Communications facilitated with the communications module 118 can, for example, have one initiating user, such as the searcher 111, and one or more potential travel partnership participants communicating through the same thread. For example, where multiple potential travel partnership participants have been grouped based upon their truncated location, the user can select to communicate with each of the multiple potential travel partner matches by selecting a link associated with the location.

As discussed above, the independent entity 106 can be a college or university, a business, a government, or some other party independent from the travel partner location system 102. The independent entity 106 can, for example, automatically enter users associated with the entity 106 into the user location data store 114. In some examples, the independent entity 106 can provide an opt out option to the users associated with the entity 106 to remove them from the user location data store 114. In some implementations, users can be grouped such that the potential travel partner matches contain only other users associated with the independent entity 106. For example, students who attend Emory University and search for a travel partner match would receive results containing only Emory University students, faculty, and staff. In other implementations, users can find travel partner matches that contain users both associated and not associated with the independent entity 106. The independent entity 106 can, for example, be any number of independent entities.

In some implementations, an incentive provider 108 can provide incentives to the searcher 111 and or independent entity 106 for participation in a travel partner program. The incentive provider, in various examples, can include governmental organizations, carbon credit exchanges, or private entities (e.g., entities wishing to purchase carbon credits from the independent entity based upon participation of associated users in the travel partner location system). In various examples, the incentives provided by the incentive provider 108 can include carbon credits, cash, discounts, special privileges, points, or free products or services, among many others. Incentive provider 108 can offer incentives directly to the searcher 111, or through a clearinghouse interface presented by the interface module 112 on the user device 104. An entity, such as the independent entity 106, can provide incentives that can be redeemed at a third party or that can be redeemed through the entity itself, such as the independent entity 106. For example, a university could offer incentives that can be redeemed at a retail store or at the university itself (e.g., scholarship money).

In some implementations, the incentive received from the incentive provider 108 can be divided between the travel partner location system 102 and the searcher 111. In some examples, there can be a predetermined percentage of the incentive that is collected by the travel partner location system 102. In other examples, a percentage collected to the travel partner location system 102 can be variable based upon the use of the travel partner location system, or some other factor(s). A variable percentage, for example, can be based upon the incentive provided, or the type of incentive, such as cash, discount, or special privilege. In some implementations, the incentive can include multiple incentives offered by the incentive provider 108. For example, one incentive, such as cash or credit, can be offered to the travel partner location system 102, and another incentive, such as a discount, special privileges, or free products or services, can be offered to the user of the travel partner location system 102.

In various implementations, the incentive provider 108 can be any number of incentive providers. In some implementations, the clearinghouse interface provided by the travel partner location system 102 can allow users to redeem points or other incentives received from a plurality of incentive providers at one place, thereby minimizing the time and effort spent by users to apply for and receive the incentives.

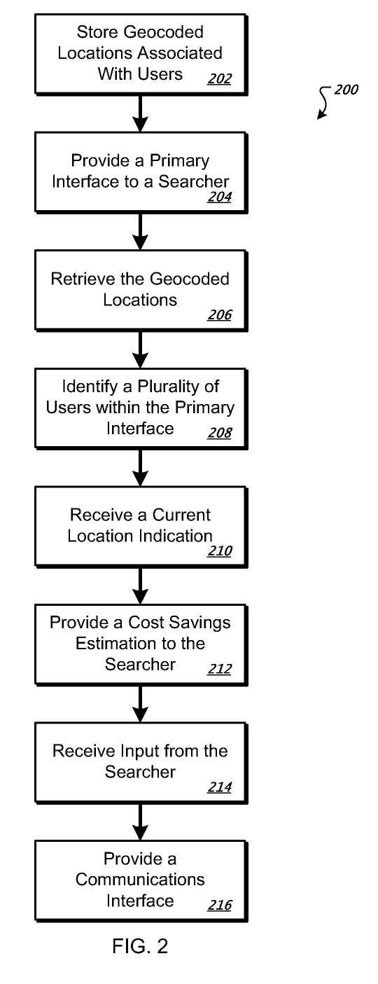

FIG. 2 is a flowchart illustrating an example method for travel partner matching. The operations 200 can, for example, be performed by the travel partner location system 102 to provide the searcher 111 with a travel partner match. The operations 200 will be described with reference to the system of FIG. 1, however others systems can be used to implement the operations 200.

At stage 202, location information associated with a plurality of users can be stored. The location information can be stored, for example, using the user location data store (e.g., user location data store 114 of FIG. 1). In some implementations, the location information can include geocoded location information, such as, for example, geocoded origin information and geocoded destination information. In further implementations, other user information, such as the user contact information, can be stored.

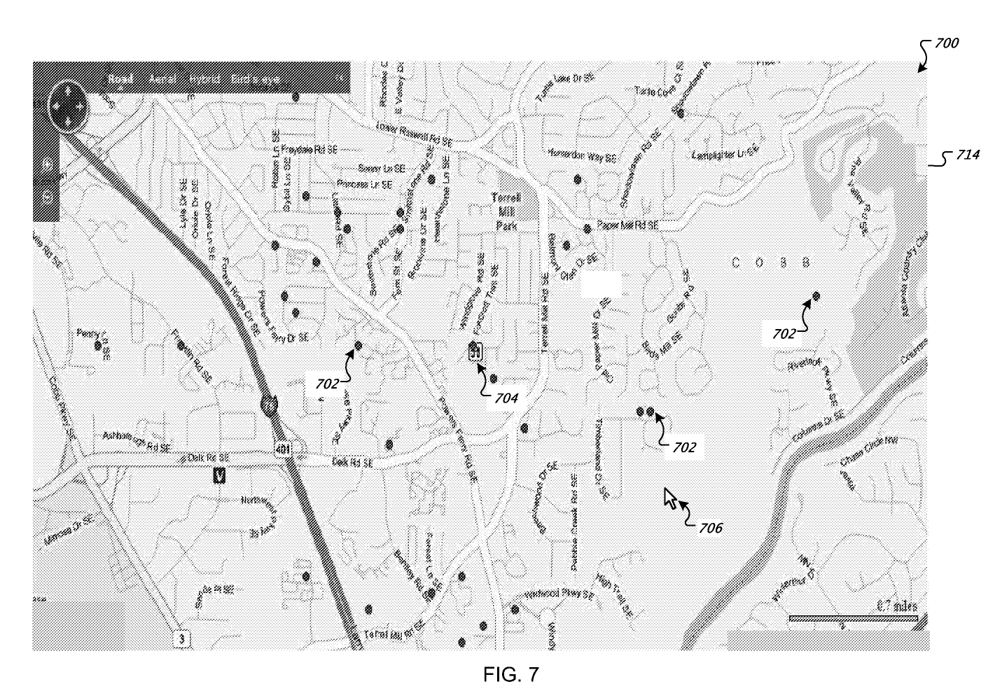

At stage 204, a primary interface is provided to a searcher. The primary interface can be provided to a searcher, for example, by an interface module (e.g., interface module 112 of FIG. 1). In some implementations, the primary interface can include a map-based user selectable interface generated by the interface module. In some examples, the primary interface can be presented in a web-based format, a widget, or some other application. In various examples, the user device (e.g., user device 104 of FIG. 1) presenting the primary interface to the searcher (e.g., searcher 111 of FIG. 1) can be a desktop computer, a laptop, a mobile device, such as a cell phone, a GPS system, or a terminal, among many others. A map-based user selectable interface is described in detail with reference to FIG. 7.

At stage 206, geocoded locations can be retrieved. The geocoded locations, for example, can be retrieved by the interface module (e.g., interface module 112 of FIG. 1). In some implementations, the retrieved geocoded locations can include location information (e.g., origin information 122 and destination information 124), or a combination thereof. The geocoded locations can include home and/or work location information associated with the plurality of users, event locations, such as a sporting event or concert, or some other locations. In some implementations, the geocoded locations can be filtered based upon a map boundary associated with a currently displayed map-based user selectable interface. For example, the interface can retrieve only those users that fall within a boundary associated with a currently displayed map.

At stage 208, a plurality of users within the primary interface can be identified. The plurality of users can be identified, for example, by an interface module (e.g., interface module 112 of FIG. 1). In some implementations, users can be identified by a marker placed on a map-based user selectable interface. The marker can be placed based upon the retrieved geocoded origin information associated with the users. The identification of the plurality of users can, for example, take into account a filter, such as a boundary defined by a zoom level on the map-based user selectable interface. For example, each time that the boundary is changed, such as by a change in the zoom level or scrolling of the map-based interface, the interface module can retrieve and identify a new set of users.

At stage 210, a current location indication is received. The current location indication can be received, for example, from a searcher (e.g., searcher 111 of FIG. 1) through the map-based user selectable interface generated by an interface module (e.g., interface module 112 of FIG. 1). In some implementations, the current location indication can be a hover indication. A hover indication can include notification of a pointer associated with the user device 104 pausing over the current location. In other implementations, the current location indication can be a mouse click on the map-based interface, a tap on a touch screen, or a voice selection, among others. The current location indication detected by the primary interface generated by the interface module can result in the display of potential travel partnership participants and related information. In some implementations, the current location indication can be popup box, a window, or embedded content, among others. The current location indication can, for example, elicit display of one potential travel partnership participants. In other implementations, more than one potential travel partnership participants can be displayed. In some implementations, the destination associated with potential travel partnership participants can be displayed to the searcher.

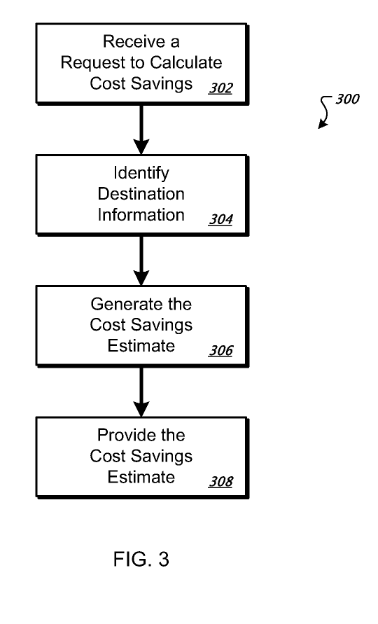

At stage 212, a cost savings estimation can be presented to the searcher. The cost savings estimation can be provided, for example, by an interface module (e.g., interface module 112 of FIG. 1) in conjunction with a cost savings estimation module (e.g., cost savings estimation engine 116 of FIG. 1). In some implementations, the cost savings estimation can be provided by the operations described below in reference to FIG. 3. The cost savings estimation module can provide the cost savings estimation to the interface module for inclusion within the map-based user selectable interface. In some implementations, the cost savings estimation can estimate the amount of money that the user could save by identifying a potential travel partnership participant at the current location indication as a travel partner, for example, to and from work. In some implementations, the cost savings estimation can include incentive factors from one or more entities, such as the incentive provider.

In some implementations, stage 210 and/or stage 212 can be repeated until the searcher finds a desirable travel partner match. The searcher can find a desirable travel partner match, for example, based on the cost savings estimation, geocoded origin information, geocoded destination information, travel partner preferences, or social networking profile, among others. In some examples, the searcher can locate a travel partner match for a round trip, such as a trip from home to work. In other examples, the searcher can locate a travel partner match for a one way trip or commute.

At stage 214, input from the searcher is received. The input can be received, for example, by an interface module (e.g., interface module 112 of FIG. 1) associated with a travel partner location system (e.g., travel partner location system 102 of FIG. 1). In some implementations, the input from the searcher can identify a selected user. For example, the selection of the user by the searcher can be performed by clicking on a communications link for the user.

At stage 216, a communications interface is provided to the searcher. The communications interface can be provided to the searcher, for example, by an interface module (e.g., interface module 112 of FIG. 1) in conjunction with a communications module (e.g., communications module 118 of FIG. 1). In some implementations, the communications interface can be generated by the communications module based upon input received from the searcher. For example, the input received from the searcher can identify the selected user and the communications module can retrieved contact information associated with the selected user and generate a communications interface. The generated communications interface can be operable to facilitate communications between the searcher and the selected user using the retrieved contact information associated with the selected user.

FIG. 3 is a flowchart illustrating an example method for estimating cost savings. The cost savings estimate can, for example, be used to provide a cost savings estimation to the searcher (e.g., as described at stage 212 of FIG. 2). The operations 300 can be described with reference to a cost savings estimation engine and a travel partner location system.

However other systems, modules, or engines can be used to implement the operations 300.

At stage 302, a request to calculate cost savings is received. The request to calculate cost savings can be received by an interface module (e.g., interface module 112 of FIG. 1). In some implementations, the request to calculate cost savings can be based upon current location information. In some implementations, the request is based on the searcher selecting a current location, for example, by hovering a pointer device over a map-based user selectable interface. The request can be forwarded to a cost savings estimation module.

At stage 304, destination information is identified. The destination information can be identified, for example, by a cost savings estimation module (e.g., cost savings estimation engine 116 of FIG. 1) in conjunction with a user information data store (e.g., user location data store 114 of FIG. 1). In some implementations, the destination information can be associated with the searcher and can include geocoded destination information stored in the user information data store. In other implementations, the destination information can be associated with the potential travel partner match, and can include geocoded destination information stored in the user information data store. For example, the destination can be a user's work or school address. In another example, the destination can be a user's home address. In some examples, a searcher might already have a ride with a relative or coworker from home to work, but might have no ride from work to home. In such examples, a travel partner location system (e.g., travel partner location system 102 of FIG. 1) can find a potential travel partner match for a portion of the user's commute.

At stage 306, a cost savings estimate is generated. The cost savings estimate can be generated, for example, by a cost estimation module (e.g., cost savings estimation engine 116 of FIG. 1). The cost savings estimate can, for example, be an estimate of the potential money saved by participating in a rideshare or travel partnership. For example, the cost savings estimate can be based upon vehicle maintenance costs, start and destination location, energy prices, and driving conditions, such as traffic and weather, availability of HOV lanes, etc. Energy prices can include gas, electric, hydrogen, water, and/or solar costs, to name a few examples. In the example where the travel partnership is a walking partnership, the cost savings estimate can include a health benefit analysis, a safety benefit analysis, or other cost/benefit factor in walking. In some implementations, the cost savings estimation module can take into account origin information and destination information in generating the cost savings estimate. In further implementations, the cost savings estimation module can also estimate savings based on when there is more than one travel partnership participant, for example, in a rideshare. The cost savings estimation engine can also account for drive time before the first passenger is picked up or after the last passenger has been dropped off.

At stage 308, the cost savings estimation is provided. The cost savings estimation can be provided, for example, by a cost savings estimation module (e.g., cost savings estimation engine 116 of FIG. 1) or the interface module (e.g., interface module 112 of FIG. 1). In some implementations, the cost savings estimation can be embedded within the map-based user selectable interface generated by an interface module for presentation to the searcher. The cost savings estimation can, for example, be presented on the user device within a web browser, a widget, or some other application. In some implementations, the cost savings estimation can be used as the cost savings estimation of step 212 described in reference to FIG. 2 above.

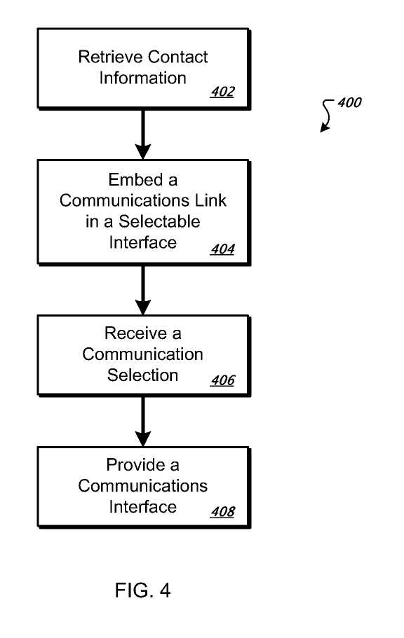

FIG. 4 is a flowchart illustrating an example method for contacting a potential travel partnership participant. The operations 400 can be performed to allow communications between users of a travel partner location system, such as a travel partner location system (e.g., travel partner location system 102 of FIG. 1). The operations 400, for example, can operate to define a process provided to stage 216 of FIG. 2. The operations 400 are described with reference to the communications module 118 and the travel partner location system 102. However, the operations 400 are not limited to the particular implementation of the travel partner location system 102 of FIG. 1. Other modules or systems can be used to implement the operations 400.

At stage 402, contact information is retrieved. The contact information can be retrieved, for example, by a communications module (e.g., communications module 118 of FIG. 1) in conjunction with a user information data store (e.g., user information 120 of FIG. 1). In some implementations, the contact information includes an e-mail address associated with a plurality of users. The communications module can generate communication links for each of the users. In some implementations, the generated communication links can obfuscate the contact information associated with the users such that any potential travel partner matches remain anonymous.

At stage 404, a communications link is embedded within the map-based user selectable interface. The communications link can be embedded, for example, by an interface module (interface module 112 of FIG. 1) in conjunction with a communications module (e.g., communications module 118 of FIG. 1). In some implementations, the communications link can be embedded within the map-based user selectable interface such that when the current location is identified, the communications links associated with the current location are presented to the searcher within the map-based interface. In some implementations, a current location can be identified based upon determining that a pointer device has hovered over a location for a period of time. For example, a hover indication can identify the current location and a popup providing communication links to the associated potential travel partner matches can appear. The communications links can, for example, be user selectable and depicted as a hyperlink.

At stage 406, a communication selection can be received. The communication selection can be received, for example, by an interface module (e.g., interface module 112 of FIG. 1) through a map-based user selectable interface generated by the interface module. In some implementations, the communication selection is associated with one or more of the communications links provided within the map-based user interface. The communication selection can be sent from the user device to the interface module based upon a user selecting a communication link. For example, a communications link can be selected after hovering a pointer device over a selected location and then clicking a pop-up window representation including a communications link representation.

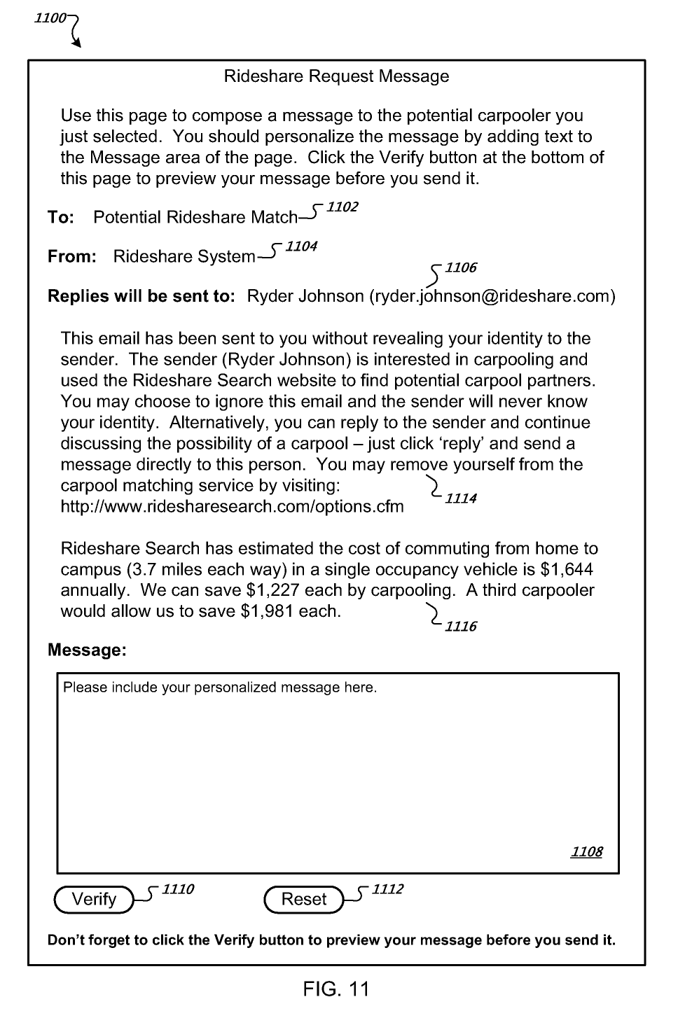

At stage 408, the communications interface is provided. The communications interface can be provided, for example, by a communications module (e.g., communications module 118 of FIG. 1) in conjunction with an interface module (e.g., interface module 112 of FIG. 1). In some implementations, the communications interface can be provided responsive to the receipt of the communication selection. The presentation of the communications interface can facilitate communications between the searcher and a selected user associated with the selected communications link received through the map-based user selectable interface. In some implementations, the communications interface can be generated by the communications module for presentation on the user device. The communications module, for example, can provide the communications interface described below in reference to FIG. 11.

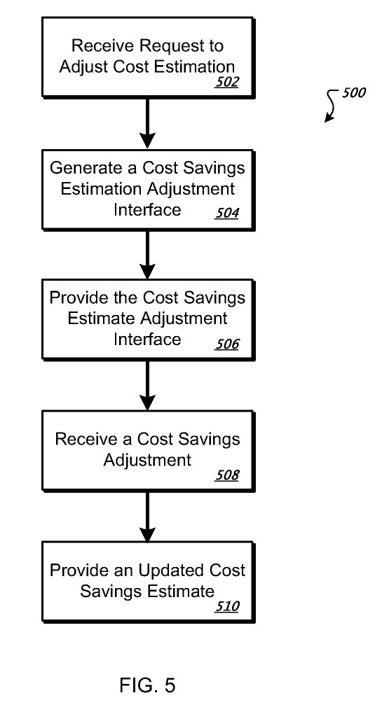

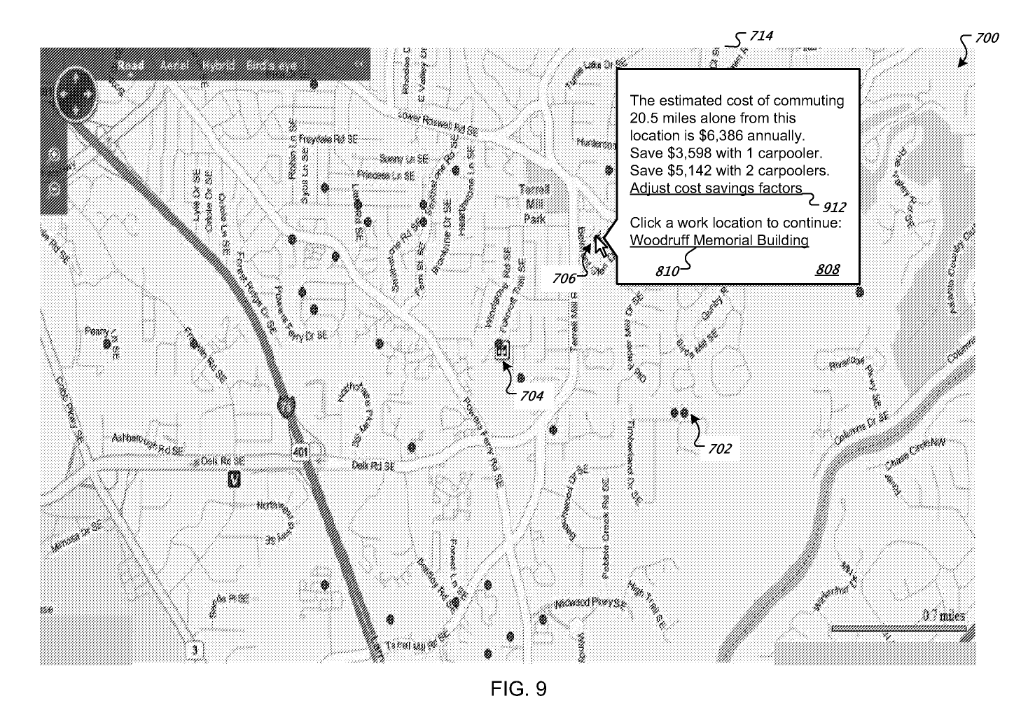

FIG. 5 is a flowchart illustrating an example method for adjusting a cost savings estimate. The operations 500 can be implemented in a system enabling a user to adjust (e.g., correct) a cost savings estimate. The operations 500 are described with reference to the cost savings estimation engine 116 and the travel partner location system 102 of FIG. 1. However, other modules, engines, or systems can be used to implement the operations 500. The operations 500 can, for example, be executed upon the selection of an adjust cost savings factors link described below in reference to FIG. 9.

At stage 502, a cost savings estimation adjustment request is received. The cost savings adjustment request can be received, for example, by an interface module (e.g., interface module 112 of FIG. 1) through a map-based user selectable interface. In some implementations, the cost savings adjustment request can be signaled by a searcher selecting a cost savings adjustment link in proximity to a cost savings estimation provided to the searcher. In other implementations, the cost savings adjustment request can be received through a secondary interface. A searcher can request the cost estimation adjustment to adjust the cost savings estimation to reflect user specific information, such as, for example, gas price, vehicle maintenance, or insurance, among many others. The cost estimation adjustment request can be received by the interface module and forwarded to a cost savings estimation engine.

At stage 504, a cost savings estimation adjustment interface is generated. The cost savings estimation adjustment interface can be generated, for example, by a cost savings estimation module (e.g., cost savings estimation engine 116 of FIG. 1). In some implementations, the cost estimation adjustment interface can be responsive to the cost estimation adjustment request and based upon cost savings factors included in the calculation of the cost savings estimation. In further implementations, the cost estimation adjustment request can contain information about the particular cost savings factors to be changed. The cost savings adjustment interface, in some examples, can include providing a spreadsheet used for calculation of the cost savings estimate to a searcher for online modification. In additional implementations, the adjustments to the cost savings factors made by the searcher can be stored to a profile associated with the searcher (e.g., user information 120 of FIG. 1).

At stage 506, a cost savings estimation adjustment interface is provided. The cost savings estimation adjustment interface can be provided, for example, by an interface module (e.g., interface module 112 of FIG. 1) in conjunction with a cost savings estimation module (e.g., cost savings estimation engine 116 of FIG. 1). The cost savings estimation adjustment interface can be generated by the cost savings estimation module and provided to a searcher through the interface module. For example, the cost savings estimation adjustment interface can be presented on a user device associated with the searcher and can display cost savings factors included in the calculation of the cost savings estimation.

At stage 508, a cost savings adjustment is received. The cost savings adjustment can be received, for example, by an interface module (e.g., interface module 112 of FIG. 1). In some implementations, the cost savings adjustment can be stored to a profile associated with the searcher (e.g., user information 120) on the travel partner location system 102. In such implementations, the cost savings factor adjustments can be used in future calculations of cost savings estimations. In various implementations, the cost savings adjustment can be used in future calculations of cost savings estimations for all users of the travel partner location system, for all users associated with the same independent entity as the searcher, or for only the searcher.

At stage 510, an updated cost savings estimation is provided. The updated cost savings estimation can be provided, for example, by a cost savings estimation module (e.g., cost savings estimation engine 116 of FIG. 1) in conjunction with an interface module (e.g., interface module 112 of FIG. 1). The updated cost savings estimation can be based upon the adjusted cost savings factors received from the searcher. In some implementations, the updated cost savings estimation can be embedded within a map-based user selectable interface, whereby the updated cost savings estimation become viewable by a searcher upon hovering a pointing device over a location associated with a potential travel partnership participant.

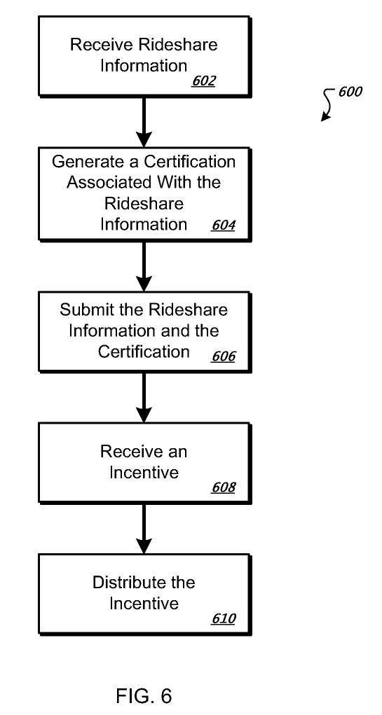

FIG. 6 is a flowchart illustrating an example method for managing travel partnership (e.g., rideshare) incentives. In various examples, the rideshare incentive can be cash, carbon credits, tickets to a special event, discounts, points, or special privileges, among many others. The operations 600 are described below with reference to an incentive distributor 108 and the rideshare location system 102 of FIG. 1. However, other entities, modules or systems can be used to implement the operations 600.

At stage 602, rideshare information can be received. Rideshare information can be received, for example, by an interface module (e.g., interface module 112). In some implementations, rideshare information can include information about rideshare, distance of the rideshare, frequency of the rideshare, etc. For example, the interface module can receives rideshare information, including start and end locations and rideshare information from the searcher. The rideshare information can, for example, be received before or after a rideshare trip. The rideshare information can include information about the frequency, consistency, and/or duration of the rideshare.

At stage 604, a certification associated with the rideshare information is generated. The certification can be generated, for example, by an interface module (e.g., interface module 112 of FIG. 1). For example, the rideshare location system can verify the rideshare information after the rideshare trip. The rideshare trip can be verified with the filling out of a form by both the rideshare partners, for example, by email, or by telephone, or other mechanism. The certification associated with the rideshare information, for example, can be generated with the verification of the rideshare information. In some implementations, verification of the rideshare information can help measure the success of the rideshare location system in finding rideshare matches and reducing traffic congestion. In some implementations, verification of the rideshare information can qualify an associated entity for receipt of carbon credits which can be sold to other entities to offset or eliminate a carbon footprint generated by the other entity. Alternatively, the carbon credits can be collected by the entity to offset their own carbon footprint.

At stage 606, the rideshare information and certification are submitted. The rideshare information and certification can be submitted, for example, by an interface module (e.g., interface module 112 of FIG. 1). In some implementations, the rideshare information and certification can be submitted to an incentive provider (e.g., incentive provider 108 of FIG. 1). The rideshare information and certification can, for example, be sent by the interface module to the incentive provider through a network. The incentive provider can include a government agency, an private entity, or a carbon credit trading market, among others, and combinations thereof. The incentive provider can use data from the rideshare information and the certification to find an appropriate rideshare incentive. The rideshare incentives can include carbon credits, money, or merchandise or service discounts, among many others. In some examples, certifications and rideshare information have differing characteristics can qualify for different types of incentives. The qualification for an incentive can be based on the cost savings estimation, the length of the rideshare trip, or the number of rideshare participants, among many others.

At stage 608, one or more incentive(s) can be received. The incentive(s) can be received, for example, by a rideshare location system (e.g., travel partner location system 102 of FIG. 1). In some implementations, the incentive(s) can be received from an incentive provider (e.g., incentive provider 108 of FIG. 1). For example, the incentive(s) can be cash, free or discounted products or services, special privileges, carbon credits, advertising benefit, or some combination of incentives. The incentive can be received via electronic network (e.g., wire or automated clearinghouse (ACH) payment, e-mail coupon, etc.), mail, delivery, or some other method.

At stage 610, an incentive can be distributed. The incentive can be distributed, for example, by a rideshare location system (e.g., travel partner location system 102 of FIG. 1). In some implementations, the distributed incentive comprises a portion of the incentive received from the incentive provider at stage 608. In other implementations, the distributed incentive is provided by the rideshare location system, and can be different in nature from the incentive provided by the incentive provider. For example, the incentive provider might provide carbon credits to the rideshare location system. However, carbon credits are relatively useless to rideshare participants. Thus, the rideshare location system can partner with entities that can use the carbon credits, in exchange for providing benefits to the rideshare participants. In some examples, the rideshare location system might partner with a university to provide incentives in the form of scholarships (e.g., partial or full scholarships) to rideshare participants, or with a retail store to provide discounted merchandise to rideshare participants. In various implementations, the incentive can be distributed in any allocation to the rideshare participants. In some examples, the rideshare location system can receive a portion of the incentive as cash or fungible commodity while the searcher and the rideshare participants might receive points. The rideshare participants can then redeem points through the rideshare location system or its partners for cash, discounts, or special offers, to name a few examples. In other implementations, the interface module can allow users with different incentive providers and/or associated with different independent entities to locate and apply for incentives through a clearinghouse interface presented on the user device. Similar incentive certification programs can be provided for walkers or bicyclists in conjunction with, for example, health insurance companies, sporting goods manufacturers, and/or carbon credit markets.

FIGS. 7, 8, and 9 are an examples of a primary interface comprising a map-based user selectable interface 700 for finding potential travel partner matches. The primary interface 700 of FIG. 7 includes geocoded location representations (e.g., geocoded location representation 702), a home location representation 704, a current location representation 706, and a boundary representation 714. An interface module can generate the primary interface for display on a user device. The map-based user selectable interface 700 displayed as the primary interface can contain different views, such as road, satellite, or hybrid, among others. Moreover, the map-based user selectable interface 700 can be manipulated. For example, the user can zoom in or out from the current view, can shift (e.g., pan) the map view. In some implementations, the user can adjust (e.g., rotate) the view or viewing angle associated with the map-based user selectable interface 700.

In certain implementations, the geocoded location can be represented by dots (e.g., geocoded location representation 702) on the map-based user selectable interface 700. The geocoded locations (e.g., including geocoded location representation 702), for example, can be generated from the location information 122 and 124 in the user location data store 114 of FIG. 1. The geocoded locations can be potential travel partner matches for the searcher. In some implementations, the geocoded locations (e.g., including geocoded location representation 702) are truncated to keep user location data anonymous. In other implementations, the geocoded locations (e.g., including geocoded location representation 702) are not truncated.

The geocoded locations (e.g., including geocoded location representation 702), for example, can include two special locations, the home location representation 704 and a current location representation 706. The home location representation 704 associated with a searcher can be the center of an initial map-based user selectable interface provided to the searcher looking for a travel partner. For example, if the geocoded locations marked on the map-based user selectable interface are truncated, a truncated geocoded location associated with the home location representation 704 might be associated with multiple users of the travel partner location system. In this example, the searcher can find a potential travel partner by hovering over or otherwise selecting the home location representation 704. The current location representation 706 can represent the current placement of a pointing device associated with a user device (e.g., user device 104 of FIG. 1).

The boundary representation 714 can filter the plurality users that are marked within the map-based user selectable interface. Those users with geocoded location information falling within the boundary representation (e.g., geocoded location 702) can be displayed within the map-based user selectable interface 700. The boundary representation 714 can act as a filter for the map-based user selectable interface 700. The filter can, for example, identify which of the plurality of users stored in a user location data store are to be displayed on the map-based user selectable interface 700. A zoom or a scroll operation can, for example, change the boundary 714 of the map-based user selectable interface 700. In some implementations, when the boundary is changed all of the geocoded location representations (e.g., including geocoded location representation 702) and the associated users are regenerated. In other implementations, some or all of the geocoded locations 702 and associated user information can be reused and only the delta between the previous boundary representation and the new boundary representation can be used to retrieve associated user locations.

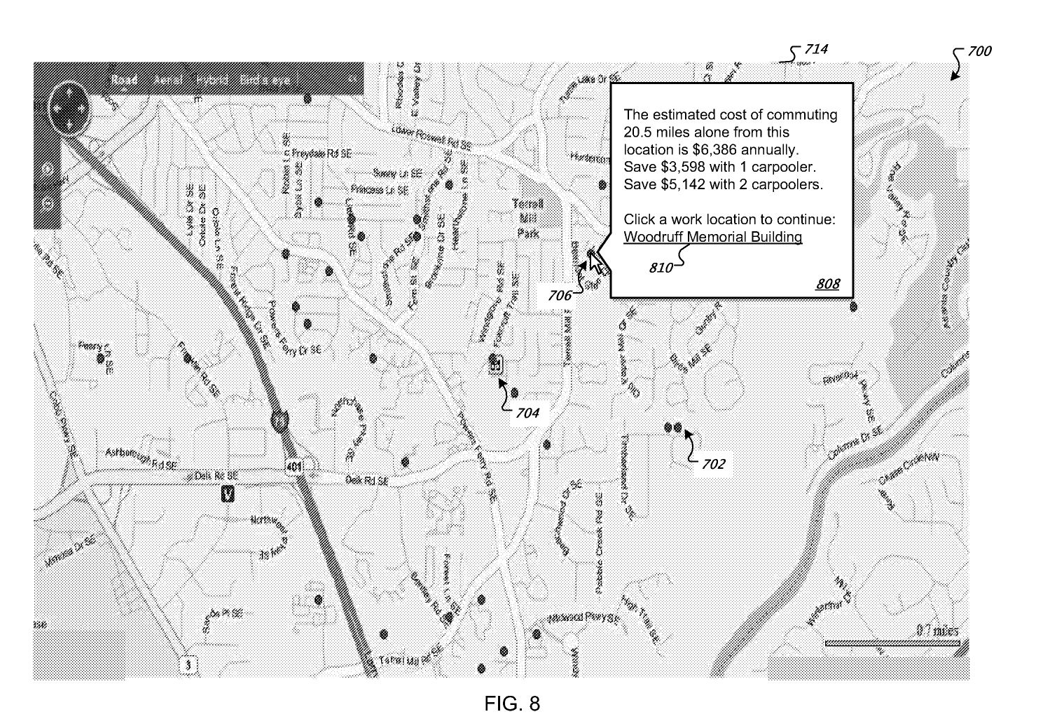

FIG. 8 is a screen shot representation illustrating another example user-selectable map interface having a current location indication and a selectable communications link. In some implementations, when a searcher hovers a pointer representation (e.g., current location representation 706) over a location having a marker indicating a potential travel partnership participant, a popup representation 808 can be provided the map-based user selectable interface 700. In further implementations, the popup representation 808 can be provided when a search uses the pointer representation to click on a marker indicating a potential travel partnership participant. Alternatively, when the user device includes a touch screen, the searcher can tap the touch screen to produce the popup representation.

In some implementations, the popup representation 808 can display travel partnership trip information, such as the distance and estimated cost savings associated with a travel partner from the current location. In some implementations, the popup representation 808 displays one or more cost savings estimations for carpooling to work based upon the number of carpoolers. In further implementations, the popup representation 808 can include one or more communications links 810

In some implementations, a communication module (e.g., communications module 118 of FIG. 1) can embed the communications link 810 into the popup representation 808 such that the communications link is not visible to the searcher until the searcher has hovered the pointer representation over an associated location marker, or otherwise selected the associated location marker. The communications link 810, upon selection, can operate to provide a communications interface to the searcher, thereby facilitating communications between the searcher and a potential travel partner. For example, selection of the communications link 810 can cause a communication module to generate a communications interface (such as, e.g., the interface described below with reference to FIG. 11) to be presented to the searcher. In various implementations, the communications interface can provide electronic mail, text messaging, or instant messaging between the searcher and the potential travel partner. Other communications protocols can be used.

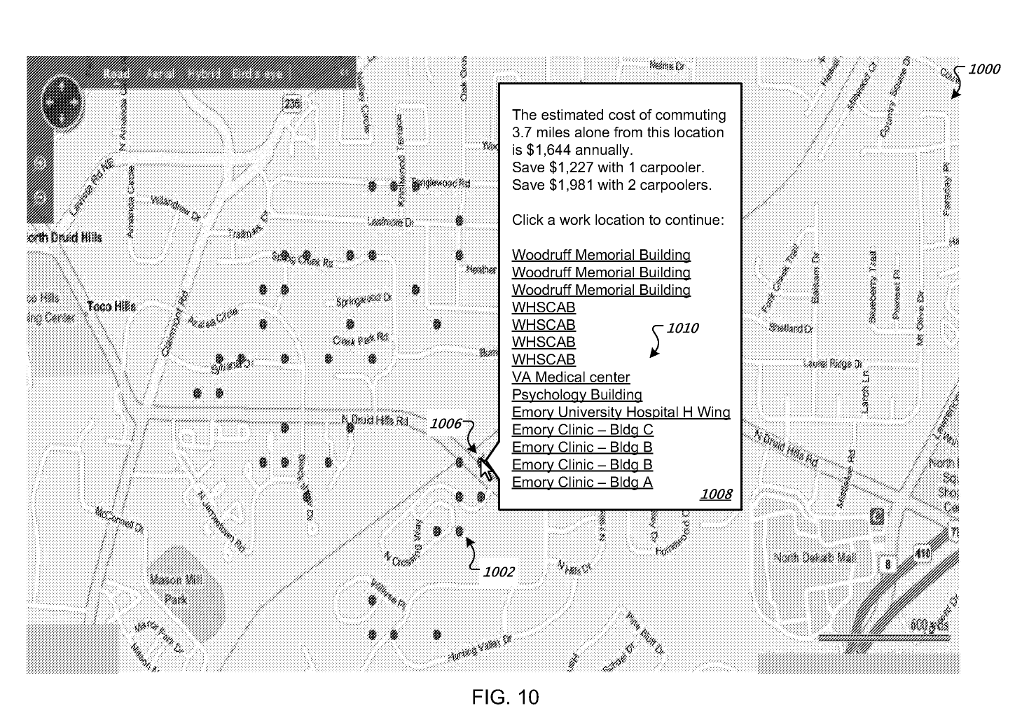

FIG. 9 is a screen shot representation illustrating another example user-selectable map interface including a current location indication, a selectable communications link and a cost savings adjustment link. The “adjust cost savings factors” link representation 912, for example, can provide a request to the travel partner location system to provide a cost savings estimation adjustment interface described below in reference to FIG. 10. The cost savings estimation adjustment interface can facilitate modification of cost savings factors included in the cost savings estimation calculated by a cost savings estimation module. For example, the searcher 111 could own a hybrid car and need to update a miles per gallon factor in the cost savings estimation. In other examples, the user can input a route associated with his/her commute, and the cost savings estimation engine can calculate the cost savings based upon the particular route provided by the user, taking into account any detour from the route provided to pick up a travel partner.

FIG. 10 is a screen shot representation illustrating another example map-based user selectable interface showing potential travel partner users using truncated geocode information. The map-based user selectable interface 1000 can include truncated geocoded location marker 1002, a current location representation 1006, and a popup representation 1008 including multiple communications links 1010. The user location data store 114 can, for example, contain geocoded locations information (e.g., location information 122, 124) which can be truncated and used to generate the truncated geocoded location markers (e.g., including truncated geocode location marker 1002). The truncated geocoded location markers can be displayed within the map-based user selectable interface 1000 so that the location information associated with each of the users included in the travel partner location system is anonymous. In such implementations, the truncation of the geocode location information can cause the map-based user selectable interface to display the truncated geocode location markers in a uniform grid pattern. Thus, the truncated geocode location marker might not necessarily even be placed on a street, but can be placed at the center of a grid block. It should be understood that such truncated geocoded locations markers cause the geocode location information associated with the users to be non-unique. Thus, in some examples, multiple users may be associated with the same truncated geocode information. In some implementations, users that are associated with identical truncated geocode location information are grouped together. Thus, each user associated with a geocode location that falls within a grid block is associated with the marker placed at the center of such grid block.

In this example, the popup representation 1008 associated with the selected location 1006 (e.g., based on a hover indication) includes multiple embedded communications links 1010. In some implementations, each of the communication links 1010 can be associated with a user residing within the grid block marked by the geocode location marker 1006. For example, there are three potential travel partners traveling to the “Woodruff Memorial Building,” and each of those users is associated with a separate communication link 1010.

In other implementations, potential travel partners that are traveling to the same building as other potential travel partners can be grouped in the same communication link 1010. For example, the popup 1008 might only include one communication link to the “Woodruff Memorial Building.” In such implementations, the communications link can indicate how many potential travel partners are associated with that building. In further implementations, selection of the single communications link associated with the multiple potential travel partners that commute to the same building can cause a communication interface to send a communication to each of those potential travel partners. Thus, for example, when the searcher selects the “Woodruff Memorial Building” communications link (which is associated with three users in this example), the selection causes the communications module to generate a communication interface which can be provided to the searcher through the interface module to facilitate communications between the searcher and the three potential travel partners. In various implementations, the communication interface can facilitate communications between the searcher and the three travel partner matches via email, a chat forum, instant messaging, or text messaging, among many others. In some implementations, the protocol used to provide communications to a potential travel partner can be based on the contact information provided by the potential travel partner. For example, the potential travel partner might have indicated a preference to receive communications via text messaging using a mobile phone number provided to the travel partner location system, or via e-mail using an electronic mail address provided to the travel partner location system, among many others, and combinations thereof.

FIG. 11 is a screen shot representation illustrating an example communications interface used to contact potential travel partner matches. In some implementations, the communications interface 1100 can include a “send to” user name 1102, a “from” user name 1104, a reply address 1106, a personalized message 1108, a verify button 1110, and a reset button 1112. The communications interface 1100 can, for example, facilitate communications between a searcher and one or more potential travel partners. In various implementations, the communications between the searcher and potential travel partner(s) can be in the form of email, chat forum, text messages, instant messaging, or telephone communications, among others. The user information 120 can, for example, contain user preferences for the preferred communication type.

In some implementations, the “send to” user name 1102, the “from” user name 1104, and/or the reply address 1106 can be hidden from the searcher. In other implementations, such information can be provided through the use of aliases that do not give a full description of the person originating the communication and/or the person receiving the communication. Thus, for example, the searcher and the potential travel partner can remain anonymous until the respective parties decide to reveal their identity.

The communications interface 1100 can contain default communications values such as the send to user name 1102, the from user name 1104, and the reply to address 1106, e.g., based upon a profile associated with the searcher/user. In some implementations, the default communications values cannot be modified. In other implementations, some of the values can be changed by the searcher based upon the available communication types available. For example, the default communication values may use an email address for the communication method and the searcher may wish to select a forum because there are a large number of potential travel partner matches.

In some implementations, the communications interface 1100 can include an automatically generated message 1114 and a cost savings estimation 1116. The automatically generated message 1114, for example, can include information about the sender and instructions on how to respond to the message. The details can change based on the communication type and/or based upon whether the interface is meant to retain anonymity of the parties. The cost savings estimation 1116, for example, can include information on an estimated amount of money both the searcher and the potential travel partner match might save if they decide to carpool together.

The personalized message 1108 can allow the searcher 111 to communicate with the potential travel partner information about the travel partnership trip, information about the searcher, or can provide a mechanism by which to start a conversation with the potential travel partner match. The searcher can select the verify button 1110 in order to preview the message before it is sent. Alternatively, the searcher can selected to erase the personalized message 1108 by selecting the reset button 1112.

The various aspects of the subject matter described in this specification and all of the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject matter of this specification has been described in terms of particular embodiments, but other embodiments can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims. The same experimental techniques work for any web page, not merely advertising landing pages. Any web site owner can experimentally determine how good his or her web site design is and which web pages should be targeted for improvement. The web site owner merely needs to designate a test page and a goal page. A goal rate can be calculated as the percentage of browsing users who, having reached the test page, go on to reach the goal page. The goal rate can be interpreted as a measure of success. In this specification, in order to adopt the commonly used terminology, “landing page” is used to include all test pages whether or not arrived at through an advertisement, and “conversion page” is used to include all goal pages.

These and other implementations are within the scope of the following claims.

1. A travel partner location system comprising:
a user location data store operable to store geocoded locations associated with a plurality of users, including a searcher, the geocoded locations comprising geocoded origin information and geocoded destination information;
an interface module operable to:
generate a primary interface comprising a map-based user selectable interface for presentation to the searcher;
retrieve the geocoded locations associated with the plurality of users;
identify the plurality of users on the map-based user selectable interface using the retrieved geocoded origin information;
receive a hover indication from the user through the map-based user selectable interface when the searcher hovers a pointer representation over a marked location within the map-based user interface;
identify a current location associated with the hover indication; and
present a cost-savings estimation to the searcher within the map-based user selectable interface based upon the current location; and
update the map-based user interface based upon input received from the searcher;
identify a selected user based upon input received from the searcher;
a communications module operable to provide a communications interface to the searcher through the interface module and responsive to the interface module identifying a selected user, the communications module and communications interface being operable to facilitate communications between the searcher and the selected user.

2. The system of claim 1, further comprising a cost savings estimation engine operable to be included within the map-based user selectable interface, the cost savings estimation engine being further operable to:
receive a request from the map-based user selectable interface to calculate cost savings based upon a current location;
identify a destination location associated with the searcher from among the geocoded destination information stored by the user location data store;
generate the cost savings estimation associated with the current location; and
provide the cost savings estimation to the map-based user selectable interface for presentation to the searcher.

3. The system of claim 2, wherein the cost savings estimation engine is configured such that when the pointer representation is hovered over a different marked location within the map-based user interface an updated cost savings estimation is derived, and the web-based user interface is configured to present the updated cost savings estimation responsive to detection of the pointer representation being hovered over the different marked location.

4. The system of claim 2, wherein the cost savings estimation includes incentive factors from one or more entities to participate in the travel partner location system.

5. The system of claim 1, wherein the communications module is further operable to retrieve contact information associated with the plurality of users and to generate a communications link,
wherein the interface module is further operable to:
receive the communications link from the communications module;
associate the communications link with respective geocoded origin information;
embed the communications link within the map-based user selectable interface such that when the hover indication is identified, the communications link is presented to the searcher within the map-based user interface; and
receive a communication selection associated with the communications link from within the map-based user interface;
wherein the communications module is operable to generate the communications interface responsive to receipt of the communication selection through the interface module, thereby facilitating communications with the selected user based upon the communication selection received from the map-based user interface.

6. The system of claim 5, wherein the communications interface generated by the communications module is operable to facilitate anonymous communication between the selected user and the searcher through the communications module.

7. (canceled)

8. The system of claim 1, wherein the user location data store is operable to truncate the geocoded origin information associated with the plurality of users, thereby obfuscating the actual location of the users and grouping users having the same truncated geocode origin information into clusters.

9. The system of claim 1, wherein the interface module is further operable to:
receive a cost savings adjustment request from the searcher through the map-based user interface;
generate a cost estimation adjustment interface responsive to the request and based upon cost savings factors included in the calculation of the cost savings estimate by the cost savings estimation engine; and
present the cost estimation adjustment interface to the user, thereby facilitating adjustment of the cost savings factors by the searcher, the cost savings estimation engine being operable to provide an updated cost savings estimate based upon the adjusted cost savings factors received from the searcher.

10. (canceled)

11. The system of claim 1, wherein the map-based user selectable interface comprises a boundary defined by a zoom level associated with the map-based user selectable interface, the boundary being operable to serve as a filter for the plurality of users retrieved from the user location data store to produce boundary matched users, the interface module being operable to retrieve location information associated with the boundary matched users and to identify the boundary matched users on the map-based user selectable interface using the retrieved location information, wherein each time the boundary is changed, the interface module is operable to retrieve a new set of boundary matched users based upon a changed boundary.

12. The system of claim 1, wherein each of the plurality of users are associated with a common entity independent of the travel partner location system and have been automatically included in the user location data store and can opt out of inclusion in the user location data store based upon providing an opt out notification to the common entity.

13. A travel partner searching method comprising:
storing geocoded locations associated with a plurality of users, including a searcher, the geocoded locations comprising geocoded origin information and geocoded destination information;
providing a primary interface comprising a map-based user selectable interface for presentation to the searcher,
retrieving the geocoded locations associated with the plurality of users;
identifying the plurality of users on the map-based user selectable interface based upon the retrieved geocoded origin information,
receiving a hover indication from the user through the map-based user selectable interface, the hover indication being associated with a current location within the map-based user interface;
presenting a cost-savings estimation to the searcher within the map-based user selectable interface based upon the hover indication;
receiving input from the searcher identifying a selected user; and
providing a communications interface to the searcher based upon receiving input from the searcher identifying the selected user, the communications interface being operable to facilitate communications between the searcher and the selected user.

14. The method of claim 13, further comprising:
receiving a request to calculate cost savings based upon a current location;
identifying a destination location associated with the searcher from among the geocoded destination information stored by the user location data store;
generating the cost savings estimation associated with the current location; and
providing the cost savings estimation to the map-based user selectable interface for presentation to the searcher.

15. The method of claim 13, wherein the cost savings estimation includes incentive factors from one or more entities to participate in the travel partner location system.

16. The method of claim 13, further comprising
retrieving contact information associated with the users and to generate associated communications links;
embed the communications link within the map-based user selectable interface such that when the hover indication is identified, the communications links associated with the current location are presented to the searcher within the map-based user interface;
receiving a communication selection associated with the communications link from within the map-based user interface; and
providing the communications interface responsive to receipt of the communication selection, thereby facilitating communications with the selected user based upon the communication selection received from the map-based user interface.

17. The method of claim 16, wherein the communications interface is operable to facilitate anonymous communication between the selected user and the searcher.

18. The method of claim 16, further comprising:
truncating the geocoded origin information associated with the plurality of users, thereby obfuscating the actual location of the users;
clustering multiple similarly located users together based upon the truncated geocoded origin information; and
providing a single communications link to clustered users;
wherein selection of the communications link is operable to facilitate communications with the clustered users.

19. The method of claim 13, further comprising:
receiving a cost savings adjustment request from the searcher through the map-based user interface;
generating a cost estimation adjustment interface responsive to the request and based upon cost savings factors included in the calculation of the cost savings estimation; and
providing the cost estimation adjustment interface to the user, thereby facilitating adjustment of the cost savings factors by the searcher; and
providing an updated cost savings estimate based upon the adjusted cost savings factors received from the searcher.

20. The method of claim 13, further comprising
receiving travel partner information from the searcher;
generating a certification associated with the travel partner information;
submitting the travel partner information and the certification to an incentive provider;
receiving an incentive from the incentive provider; and
distributing at least a portion of the incentive to the searcher.

21. (canceled)

22. The method of claim 13, wherein each of the plurality of users are associated with a common entity independent of the travel partner searching method.
